(19) United States
(12) Patent Application Publication
(10) Pub. No.: US 2014/0278848 A1
(43) Pub. Date: Sep. 18, 2014

(54) WEATHER-TRIGGERED MARKETING

(71) Applicant: ACCUWEATHER, INC., State College, PA (US)

(72) Inventor: James T. CANDOR, State College, PA (US)

(73) Assignee: AccuWeather, Inc., State College, PA (US)

(21) Appl. No.: 13/837,779

(22) Filed: Mar. 15, 2013

(51) Int. Cl. G06Q 30/02

(52) U.S. Cl. CPC G06Q 30/0252
USPC 705/14.5

(57) ABSTRACT

Both weather data and information about a user based on that user's behavior are used to generate an advertisement, which is then sent to the user. That can be accomplished without having the user explicitly input information about preferences.

### FIELD OF THE INVENTION

The present invention is directed to weather-triggered marketing and more particularly to weather-triggered marketing that is not limited to weather sites and that more particularly matches a user's interests.

### DESCRIPTION OF RELATED ART

Weather is a top audience draw in both new and traditional media. Weather is the number-one type of data downloaded on mobile phones. On the Internet, two-thirds of all users view weather information. An accurate local weather forecast is the top reason that viewers give for choosing a television news broadcast. The weather forecast is one of the top three reasons for which listeners choose a radio station.

Weather-triggered marketing has been commonly done for years on AccuWeather.com (ADC) and other weather sites. For example, when the temperature in a locality is above 85 degrees, an advertisement for a product related to heat can be shown to users in that locality. For example, the advertisement can be for a brand of lemonade or for an air conditioning system. Similarly, when the temperature is low in a locality, the advertisement shown to users in that locality can be for a brand of hot cocoa, a winter coat, or a vacation package in Florida. Weather-triggered advertising is also known in the art for other goods whose sales are heavily weather-dependent, such as fertilizer and other gardening supplies. Weather-triggered marketing is known to reduce cost per sale and increase sales volume.

It has been known at least since 2005 (http://www.clickz.com/clickz/column/1710140/rain-shine-weather-triggered-advertising-is-fine) that weather-triggered advertising on Web sites comes in two forms: advertising on or through one of the primary providers of online weather forecasting and ads that appear on non-weather Web sites that are specifically triggered and served according to the weather forecast in the user's region. If the user is using a computer or non-GPS-enabled device, the user's approximate location can be determined, e.g., through the user's IP address. If the user is logged in to the site, the site can determine the user's location through the address that the user provided during registration. Also, ads can be served for where a person might be headed, based on the location of the forecast selected. For example, if the GPS location or IP address indicates a person is in New York City, but the user selects a forecast for San Francisco, we can assume the user is planning to go to San Francisco and deliver an ad appropriate to the weather for San Francisco.

Another use for weather-triggered marketing is digital signage in retail locations. For example, a weather forecast on the display of a convenience store gas pump can feature the current temperature, whether hot or cold, reinforcing the accompanying ad—and the viewer's desire—to go inside for a soft drink or a cup of coffee. The weather forecast on digital signage in a pharmacy waiting area explains how the upcoming changes in the weather increase the likelihood of arthritis or migraine pain or asthma attacks—creating demand for over-the-counter remedies. Visitors to a big-box food and home store view the day's weather forecast for popular outdoor recreation sites, for sports ranging from running to fishing, or for entertainment activities such as backyard grilling.

In all of those examples, weather plays a key role in determining what advertisements will be displayed in each location, based on weather conditions, forecasts and other weather-related information. Advertisements can be run in local markets based on geographic location and time of day.

Weather-triggered marketing has also long been known in traditional media. For example, in 2004, the cruise line Royal Caribbean International introduced an advertising campaign both in new media and on local television stations that would run in certain markets only when the weather was cold or snowy (http://www.nytimes.com/2004/12/28/business/media/28adco.html?_r=0).

Weather-triggered marketing as described above is extremely non-specific in that it does not take into consideration individual users' preferences or, for that matter, just about any information except weather at a specific location. For example, even when it is snowing in Boston, it does not follow that any particular television viewer wants to take a Caribbean cruise. Thus, such marketing can still be less well targeted than would be desirable.

U.S. Patent Application Publication Nos. 2007/0162328 A1 and 2011/0004511 A1 teach weather-triggered marketing to consumers in a defined place and time. The marketing is optionally also based on a consumer characteristic, which the consumer has previously input. More specifically, the end user may submit such a characteristic through a GUI or other interface, or through any other type of communication. Examples of such user characteristics include but are not limited to, user skin type, including various sensitivities (ability to withstand the sun for a person with dark skin); hair type; eye color (for sensitivity to sun and heat); user age (optionally including age groups e.g. student, college student, business people, retired, young mothers etc.); marital status (married, engaged, searching for a mate, etc.); various user hobbies including but not limited to favorite sport, favorite team, etc.; health related issues (including weight, allergies, heart problems etc.); eating habits; fashion and clothing preferences; and consuming habits. Weather can be correlated to consumer spending habits by receiving a database of such consumer spending habits and performing statistical and economic analysis to abstract a weather sensitive demand curve based on weather and product sales data.

However, since it is well known that users often either refuse to submit such characteristics or lie when submitting such characteristics, it would be helpful to be able to derive more realistic information regarding the preferences of individual consumers. Also, producing the demand curve necessarily relies on aggregate consumer spending habits and has very little relevance to any particular consumer's spending habits.

### SUMMARY OF THE INVENTION

There thus exists a need in the art to make weather-triggered marketing more targeted and easier to implement.

It is thus an object of the invention to provide weather-triggered marketing that is better tailored to individual consumers.

It is another object of the invention to provide weather-triggered marketing that is not limited to weather sites.

The present invention expands weather-triggering to be not just on weather sites, but potentially across all web sites. A provider of weather data might work out a deal with a large conglomeration of advertisement networks serving advertisements to many thousands of web sites. If the provider of weather data can tell that large conglomeration where the temperature is above 85° F., the advertisement networks can sell a campaign to the company that sells the lemonade to deliver their advertisements across a whole range of web sites when the weather is best for buying lemonade.

The present invention implements a system and methodology to maximize performance of digital advertisements by using weather variables as a factor in determining what ads to serve to a user in a particular location. Maximizing performance is defined as increased user reaction and/or interaction with the advertisement or promotion in question.

The invention can be implemented on the following, or in other communication media:
a. Any platform with an IP connection through which advertisements are served. Examples include, but are not limited to:
   i. Web
   ii. mobile web
   iii. mobile apps
   iv. tablets
   v. PCs
   vi. Laptops
   vii. Smart TV
   viii. Place-Based
b. Non-IP based delivery systems for traditional media outlets, including:
   i. TV
   ii. Radio
   iii. Newspaper
   iv. Devices or platforms that have a catalogue of advertisements and can determine which ad to serve based on various criteria.
   v. Ads can be “standard” banners and text displays, videos or content integration on publisher outlet

Types of triggering include anything that is related to past, current or future weather, as well as lifestyle and other impacts based on the weather. Examples include, but are not limited to:
a. Temperature
b. Cloud cover
c. Humidity
d. Winds
e. AccuWeather RealFeel Temperature®
f. Precipitation amount
g. Precipitation type
h. Resultant lifestyle impacts. Examples include, but are not limited to:
   i. Hair frizz
   ii. Allergies
   iii. Sinus Headaches
   iv. Migraines
   v. Flu
   vi. Wet roads
   vii. Icy or snowy roads
   viii. Delayed road or air travel
   ix. Entertainment choice
   x. Food and beverage choices

Potential customers include advertising networks; advertising exchanges, whether programmatic or non-programmatic; ad agencies; advertising brands; advertising server networks; and private publisher exchanges or server networks.

A company implementing the present invention can provide triggering information to other publishers or networks/exchanges, etc., about users who have visited that company's site or other properties where that company has user intelligence. Advertisements may or may not include weather information. Weather triggering can be combined with other triggering methods, such as location, device, behavioral targeting and contextual targeting.

The weather information can be provided to any advertising network (defined as an entity that distributes advertising for multiple brands), advertising agency (an entity that envelops and pays for distribution of ads on the behalf of a brand), or advertising server (an entity that serves ads to end users for various publisher sites).

An advertising conglomeration can include Google's AdExchange, 24/7 Real media, Pubmatic, Amobee, Sprint, Telefonca, or any of several more. Weather is ideal in the mobile space because it allows for super localization (the user's GPS coordinates can be determined) and weather targeting, which can improve the relevance of the advertisements delivered.

The manner in which the information is provided can be one of several possibilities, from providing a pre-defined feed of weather information for locations around the country or around the world to providing an API that pings the weather company's servers any time an ad is being requested to use as an input in the network. That can be effectively done in any way permitted by the technology and can be done on a push or pull basis.

Weather would be one of perhaps several ingredients used in determining an advertisement. Google Ad exchange has tens of thousands of advertisements to choose from at any point in time for each of the billions and billions of ads they serve per month, and they try to do this by determining what will yield the most money for the publisher (and for Google). Factors include location, demographic profile of the site's users, specific known information about the particular user (such as they frequent golf sites, so a golf ad might be relevant) to the weather, the time of the day, day of the week and on and on.

Instead of negotiating a deal with a specific advertising company, a weather company can simply provide the feed and allow anyone to use it in the context of the present invention.

The present invention is not limited to weather-triggered marketing, but can instead be generalized to any form of event-triggered marketing, e.g., environment-triggered marketing.

Communicator devices that can be used with the present invention include any electronic wireless device to include but not limited to a mobile phone network, a mobile phone network with wireless application protocol, Internet, facsimile network, a satellite (one or two-way), RF radio network, or sensor. For that matter, the invention is not limited to use with electronic wireless devices, but can instead be used with any other way of transmitting information from a source to an end user.

### BRIEF DESCRIPTION OF THE DRAWINGS

A preferred embodiment of the present invention will be set forth in detail with reference to the drawings, in which:

FIG. 1 is a flow chart showing one possible operation of the preferred embodiment;

FIG. 2 is a diagram of a communication network on which the preferred embodiment can be implemented; and

FIGS. 3A and 3B are simulations of screen shots of advertisements that can be generated for specific users in accordance with the preferred embodiment.

### DETAILED DESCRIPTION OF THE PREFERRED EMBODIMENT

A preferred embodiment will now be set forth in detail with reference to the drawings. The specific technology used, such as servers and communication networks, will be familiar to those skilled in the art who have reviewed the present disclosure and will therefore not be disclosed in detail here.

As shown in FIG. 1, in step 102, the weather service provides a stream of weather data in a known manner. As noted above, step 102 can be carried out in a push manner or in a pull manner; the latter can occur, e.g., when a user requests information. In step 104, the end user takes certain actions that express certain interests. Examples include visiting an apartment web site to search for apartments in a certain city and doing a web search for a topic of interest. In the former case, it can be determined that the user is searching for apartments in city A rather than houses in city B. In that case, it is a safe bet that bedding plants will be of little or no interest to that user, particularly if they are not hardy in city A. In step 106, the advertising agglomerator receives the stream of weather data and the information regarding the user's interests. In step 108, the advertising agglomerator generates a personalized, weather-specific advertisement and transmits it to the user, e.g., by providing it as a banner advertisement. That advertisement may or may not include such information as current weather information for that location and a weather forecast for that location. In step 110, the user receives and preferably views and clicks on the advertisement (or takes whatever other action is appropriate, depending on the medium).

Thus, the user does not have to have already input information about that user's preferences in order to receive advertisements based on such preferences. For example, if one user has been searching for apartments, the system can determine that that user will most likely not be receptive to advertisements for weather-related home improvements such as new air conditioning system. If another user has been browsing home-improvement sites, the system can determine that that user will much more likely be receptive to such advertisements.

More generally, the information concerning the user can include any information concerning the user's behavior, including which sites the user has browsed, which pages on those sites the user has accessed (e.g., which online newspapers the user accesses and whether the user is more likely to read articles on sports or on gardening), searches done by the user, and purchases made by the user. It is possible to obtain such information through known technologies such as the use of cookies in Web browsers. In fact, it is known that some Internet companies collect voluminous information on their users; such information could be used in the preferred embodiment. Such information gives insight into the user's needs and wants and can therefore be used to provide an advertisement to which the user will most likely be especially receptive.

In non-Internet situations, it is still possible to obtain such information. For example, the use of a reward card provides information about the user's purchases. When the user uses the reward card again, an advertisement directed to the user and based on the user's previous purchases can be provided, e.g., on a digital display near the cash register or fuel pump or on the user's receipt. In the latter case, a coupon for the advertised merchandise can also be printed on the receipt.

As an example of the weather triggering of such an advertisement, if the temperature is high in that location, and the user has made considerable clothing purchases at the store that issued the reward card, the advertisement or the coupon can be for summer clothing. Of course, information concerning the specific clothing that the user has purchased, e.g., high-end versus value-priced or fashionable versus conservative, can be used to determine what summer clothing should be advertised to the user and how sensitive the user is likely to be to coupons or sales. Similarly, a user using a reward card at a gas station when the temperature is high may see an advertisement for summer-related automotive services, which can be varied in accordance with the user's history of purchasing regular or high-octane gasoline.

The weather-triggered marketing can also take into account preference information input by the user, if desired. However, since it is well known that users often either do not fill out preference information or lie on questionnaires to sound more high-minded than they are, information concerning the user's actual behavior should be used to decide which advertisement to send.

The transmission of the advertisement to the user can be by any suitable method. Two that have been mentioned are digital displays in retail locations and in hard copy on receipts, shown in FIG. 1 as 112 and 114, respectively. Others include advertisements 116 on Web pages, email advertisements 118, and advertisements 120 sent directly to mobile devices such as smartphones. One known way to send messages to individual cellular telephones is by SMS (texting). Any suitable advertising medium can be used, as long it as has the adaptability to allow the implementation of the event-triggered marketing disclosed herein. In some advertising media, it may be wise or even obligatory to provide such advertising on an opt-in basis.

As shown in FIG. 2, the weather service's server 202 communicates via a communication medium 204, such as the Internet, with an advertising agglomerator's server 206, which in turn communicates via a communication medium 208, such as the Internet or cellular telephony, with user devices 210. The advertising agglomerator's server is configured to carry out the functionality specified above.

If the user devices 210 are the users' computers or mobile devices, such devices preferably have no special software beyond standard Web browsers and other software that the users would be expected to have on their devices. Users using their personal devices may be disinclined to install special software, especially if the purpose is to view advertisements, while users using work computers or BlackBerries or other devices provided by their employers may be forbidden to do so. If the user devices are digital displays or receipt printers at retail locations, such user devices can be custom programmed for the appropriate functionality.

The weather service 202 preferably provides a weather feed to any paying customer, who can then implement weather-triggered marketing according to that feed. A weather-triggered marketing system such as the server 206, or the software needed to implement it on a standard server, can optionally be offered as a turnkey system to any advertiser. In that regard, individual agreements do not have to be negotiated.

FIGS. 3A and 3B show illustrative examples of banner advertisements generated in accordance with the preferred embodiment.

FIG. 3A shows an advertisement 300 generated for a user in Phoenix whose shopping history indicates a taste for the latest fashions and for low prices. The advertisement includes weather information 302 for the locality and advertising material 304 derived from the weather in the locality and the user's shopping habits.

FIG. 3B shows an advertisement 306 generated for a user in Nome, Ak., whose shopping history shows that that user is not sensitive to current fashion or to price. The advertisement includes weather information 308 for the locality and advertising material 310 derived from the weather in the locality and the user's shopping habits. The weather information can include current weather information only, weather information over the day, a forecast over a number of days, or whatever else is desired, or it can be omitted.

The sorts of advertisements shown in FIGS. 3A and 3B can be adapted for other media. For example, if weather-targeted promotional material is printed onto a shopper's receipt, the shopper who would view the advertisement 300 of FIG. 3A can instead receive a dollars-off coupon.

Such advertisements can be generated completely on the fly. Another way to generate them is to store multiple advertisements and to direct them as needed. It is known that some advertising agglomerators can store tens of thousands of advertisements and direct them as needed; the weather-triggered marketing of the preferred embodiment can enhance that functionality.

As noted above, the present invention can be generalized from weather-triggered marketing to broader event-triggered marketing. The event can be a news event such as the most recent papal election, a sports event such as a victory by a team whose market includes the relevant locality, or any other such event. For example, when the local football team wins, users who have a history of browsing sports sites can receive advertisements for team memorabilia, while such advertisements will not be wasted on users who do not have such a history. Thus, the preferred embodiment, or any other embodiment of the present invention, can further reduce cost per sale.

The invention is not limited to weather triggering. For example, environmental triggers events such as pollen count or medical events can be used instead of, or along with, weather triggers.

While a preferred embodiment has been set forth above, those skilled in the art who have reviewed the present disclosure will readily appreciate that other embodiments can be realized within the scope of the invention. For example, recitations of specific companies, brands, and technologies are illustrative rather than limiting. Also, the weather used to trigger the marketing is not limited to temperature, but can include any weather condition, such as wind, current snow, or likelihood of snow. Therefore, the present invention should be construed as limited only by the appended claims.

What is claimed is:

1. A method for providing event-triggered marketing, the method comprising:
(a) receiving information concerning the event into a server;
(b) receiving information concerning a user into the server, the information concerning the user comprising information concerning the user's behavior;
(c) generating an advertisement in accordance with the information concerning the event and the information concerning the user; and
(d) providing the advertisement to the user.

2. The method of claim 1, wherein the event comprises weather.

3. The method of claim 1, wherein steps (a), (b), and (d) are performed over electronic communication media.

4. The method of claim 3, wherein the electronic communication media comprise the Internet.

5. The method of claim 4, wherein the information concerning the user's behavior comprises an identification of sites that the user has browsed.

6. The method of claim 4, wherein the information concerning the user's behavior comprises an identification of searches that the user has made.

7. The method of claim 4, wherein the information concerning the user's behavior comprises an identification of purchases made by the user.

8. The method of claim 1, wherein step (d) comprises providing the advertisement to the user as a Web advertisement.

9. The method of claim 1, wherein step (d) comprises providing the advertisement to the user on a digital display at a retail location.

10. The method of claim 1, wherein step (d) comprises providing the advertisement to the user on a printed receipt.

11. The method of claim 1, wherein step (d) comprises providing the advertisement to the user as an email message.

12. The method of claim 1, wherein step (d) comprises providing the advertisement to the user directly on a mobile device used by the user.

13. The method of claim 1, wherein step (a) is performed on a push basis.

14. The method of claim 1, wherein step (a) is performed on a pull basis.

15. A system for providing event-triggered marketing, the system comprising:
a communication component; and
a processing device in communication with the communication component, the processing device being configured for:
(a) receiving information concerning the event from the communication component;
(b) receiving information concerning a user from the communication component, the information concerning the user comprising information concerning the user's behavior;
(c) generating an advertisement in accordance with the information concerning the event and the information concerning the user; and
(d) providing the advertisement to the user through the communication component.

16. The system of claim 15, wherein the processing device is configured such that the event comprises weather.

17. The system of claim 15, wherein the communication component comprises a component for communicating over electronic communication media.

18. The system of claim 17, wherein the electronic communication media comprise the Internet.

19. The system of claim 18, wherein the processing device is configured such that the information concerning the user's behavior comprises an identification of sites that the user has browsed.

20. The system of claim 18, wherein the processing device is configured such that the information concerning the user's behavior comprises an identification of searches that the user has made.

21. The system of claim 18, wherein the processing device is configured such that the information concerning the user's behavior comprises an identification of purchases made by the user.

22. The system of claim 15, wherein the processing device is configured to carry out step (d) by providing the advertisement to the user as a Web advertisement.

23. The system of claim 15, wherein the processing device is configured to carry out step (d) by providing the advertisement to the user on a digital display at a retail location.

24. The system of claim 15, wherein the processing device is configured to carry out step (d) by providing the advertisement to the user on a printed receipt.

25. The system of claim 15, wherein the processing device is configured to carry out step (d) by providing the advertisement to the user as an email message.

26. The system of claim 15, wherein the processing device is configured to carry out step (d) by providing the advertisement to the user directly on a mobile device used by the user.

27. The system of claim 15, wherein the processing device is configured to carry out step (a) on a push basis.

28. The system of claim 15, wherein the processing device is configured to carry out step (a) on a pull basis.
